(19) United States
(12) Patent Application Publication
(10) Pub. No.: US 2009/0021227 A1
(43) Pub. Date: Jan. 22, 2009

(54) POWER-SUPPLY DEVICE, IC CIRCUIT, AND INFORMATION PROCESSING APPARATUS, AND SOFT-START CONTROL METHOD

(76) Inventors: Takashi Sase, Hitachi (JP); Yosuke Kawakubo, Odawara (JP); Kozaburo Kurita, Oume (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 12/019,761

(22) Filed: Jan. 25, 2008

(30) Foreign Application Priority Data
Jul. 17, 2007 (JP) 2007-185863

(51) Int. Cl. G05F 1/44; G05F 1/00

(52) U.S. Cl. 323/238; 323/282; 323/283

(57) ABSTRACT

An electric current flowing to an upper side power MOSFET during soft-start is detected according to an on-voltage of the MOSFET and an on-pulse width of a PWM pulse for driving the upper side power MOSFET is forced to be reset in the idle and decided according to a signal generated when the voltage falls below a predetermined specified voltage.

### BACKGROUND OF THE INVENTION

1. Field of the Invention

The present invention relates to a power-supply device, an IC circuit, and an information processing apparatus, and a soft-start control method.

2. Background Art

In a power supply (an on-chip power supply) built in an LSI such as an FPGA and a CPU chip, a reduction in size and a reduction in cost of a system and a unit through a reduction of external components are problems. In a conventional soft-start method, for example, as disclosed LM2673 datasheet of National Semiconductor Corporation, an external soft-start capacitor is used.

In some soft-start operation, for example, as disclosed in JP Patent Publication (Kokai) No. 2007-20327, external components are made unnecessary by detecting an electric current flowing to a body diode formed in a lower side power MOSFET as current detection means.

### SUMMARY OF THE INVENTION

However, in the technique disclosed in the LM2673 data sheet of National Semiconductor Corporation, since the external component is used, the technique is not suitable for an on-chip power supply for realizing a reduction in size and a reduction in cost of a unit and a system.

In the method disclosed in the JP Patent Publication (Kokai) No. 2007-20327, although an external component is unnecessary, current information is used for deciding the end of a soft-start operation for gradually increasing an on-pulse width of a PWM pulse according to program control. Therefore, even if the electric current flowing to the body diode formed in the lower side power MOSFET is used, the method is not suitable for a soft-start method for directly deciding an on-pulse width of a PWM pulse of an upper side power MOSFET.

The present invention has been devised in view of such a situation and it is an object of the present invention to realize a reduction in size of a soft-start circuit of a power-supply device without using an external component and provide a soft-start method for appropriately deciding an on-pulse width of a PWM pulse of an upper side power MOSFET.

In order to solve the problems, in the present invention, during soft-start, an electric current that flows when an upper side power MOSFET is on is detected and an on-pulse width of a PWM pulse for driving the upper side power MOSFET is forced to be turned off in the middle and decided according to a signal generated when the electric current increases to be larger than a rated current.

In other words, in the present invention, the on-pulse width for driving the upper side power MOSFET during soft-start is set according to a result obtained through an AND gate of an output pulse of a flip-flop, which is obtained as a result of setting the flip-flop at off timing of an output pulse of a pulse-width modulation type oscillator, and the output pulse of the pulse-width modulation type oscillator. On the other hand, in resetting the on-pulse width for driving the upper side power MOSFET, a voltage detected by sampling the electric current, which flows when the upper side power MOSFET is on, in a form of an ON voltage of the upper side power MOSFET and a predetermined specified voltage are compared by a comparator and the on-pulse width of the PWM pulse for driving the upper side power MOSFET during final soft-start is decided according to a result obtained through the AND gate of an output pulse, which is obtained by resetting the flip-flop according to a signal generated when the detected voltage falls below the specified voltage, and the output pulse of the pulse-width modulation type oscillator.

Further characteristics of the present invention will be made apparent by a best mode for carrying out the invention described below and the accompanying drawings.

According to a soft-start method for a power-supply device of the present invention, it is possible to realize a reduction in size of a soft-start circuit without using an external component and it is possible to appropriately decide an on-pulse width of a PWM pulse of an upper side power MOSFET.

### BRIEF DESCRIPTION OF THE DRAWINGS

FIG. 1 is a diagram showing a schematic circuit configuration of a power-supply device according to a first embodiment of the present invention;

FIG. 2 is a diagram showing timing of a soft-start operation of the power-supply device shown in FIG. 1;

FIG. 3 is a diagram showing an operation waveform of soft-start of the power-supply device shown in FIG. 1;

FIG. 4 is a diagram showing a specific circuit configuration of a comparator shown in FIG. 1;

FIG. 5 is a diagram showing a circuit configuration of a pulse-width modulation type oscillator shown in FIG. 1;

FIG. 6 is a diagram showing an operation waveform of the pulse-width modulation type oscillator shown in FIG. 5;

FIG. 7 is a diagram showing a schematic circuit configuration of a power-supply device according to a second embodiment of the present invention;

FIG. 8 is a diagram showing a schematic circuit configuration of a power-supply device according to a third embodiment of the present invention;

FIG. 9 is a diagram showing another example of the structure of a pulse-width modulation type oscillator;

FIG. 10 is a diagram showing a specific example of the structure of a one-shotmultivibrator used in the pulse-width modulation type oscillator shown in FIG. 9;

FIG. 11 is a diagram showing operation timing of a circuit shown in FIG. 10;

FIG. 12 is a diagram showing a schematic circuit configuration of a power-supply device according to a fourth embodiment of the present invention;

FIG. 13 is a diagram showing a schematic circuit configuration of a power-supply device according to a fifth embodiment of the present invention;

FIG. 14 is a diagram showing operation timing of a pulse-width modulation type oscillator shown in FIG. 13;

FIG. 15 is a diagram showing a schematic circuit configuration of a power-supply device according to a sixth embodiment of the present invention;

FIG. 16 is a diagram showing a schematic circuit configuration of a power-supply device according to a seventh embodiment of the present invention;

FIG. 17 is a diagram showing a schematic circuit configuration of a power-supply device according to an eighth embodiment of the present invention;

FIG. 18 is a diagram showing a schematic circuit configuration of a power-supply device according to a ninth embodiment of the present invention;

FIG. 19 is a diagram showing an operation waveform of soft-start of the power-supply device shown in FIG. 18;

FIG. 20 is a diagram showing an operation waveform of different soft-start;

FIG. 21 is a diagram showing a schematic circuit configuration of a power-supply device according to a tenth embodiment of the present invention;

FIG. 22 is a diagram showing operation timing of soft-start of the power-supply device shown in FIG. 21;

FIG. 23 is a diagram showing a schematic circuit configuration of a power-supply device according to an eleventh embodiment of the present invention;

FIG. 24 is a diagram showing a schematic circuit configuration of a power-supply device according to a twelfth embodiment of the present invention;

FIG. 25 is a diagram showing the structure of a power supply for information processing of a HDD device mounted with a power-supply device according to the present invention; and

FIG. 26 is a diagram showing the structure of another power supply for information processing of the HDD device mounted with the power-supply device according to the present invention.

### DETAILED DESCRIPTION OF THE PREFERRED EMBODIMENTS

A power-supply device of the present invention relates to a power-supply device of a buck DC-DC converter and detects an electric current that flows when an upper side power MOSFET is on during soft-start. The power-supply device compares the detected electric current and a predetermined specified current and forces to turn off and decide an on-pulse width of a PWM pulse for driving the upper side power MOSFET according to a signal generated when the detected electric current rises to be larger than the predetermined specified value. This makes it possible to perform a soft-start operation for gradually and smoothly building up an output voltage of the power-supply device. Consequently, a power-supply device that does not require an external soft-start capacitor is realized.

Embodiments of the present invention will be hereinafter explained with reference to the accompanying drawings. However, it should be noted that the embodiments are merely examples for realizing the present invention and do not limit the present invention. Components common to the respective drawings are denoted by same reference numerals and signs.

### First Embodiment

### (1) Circuit Configuration

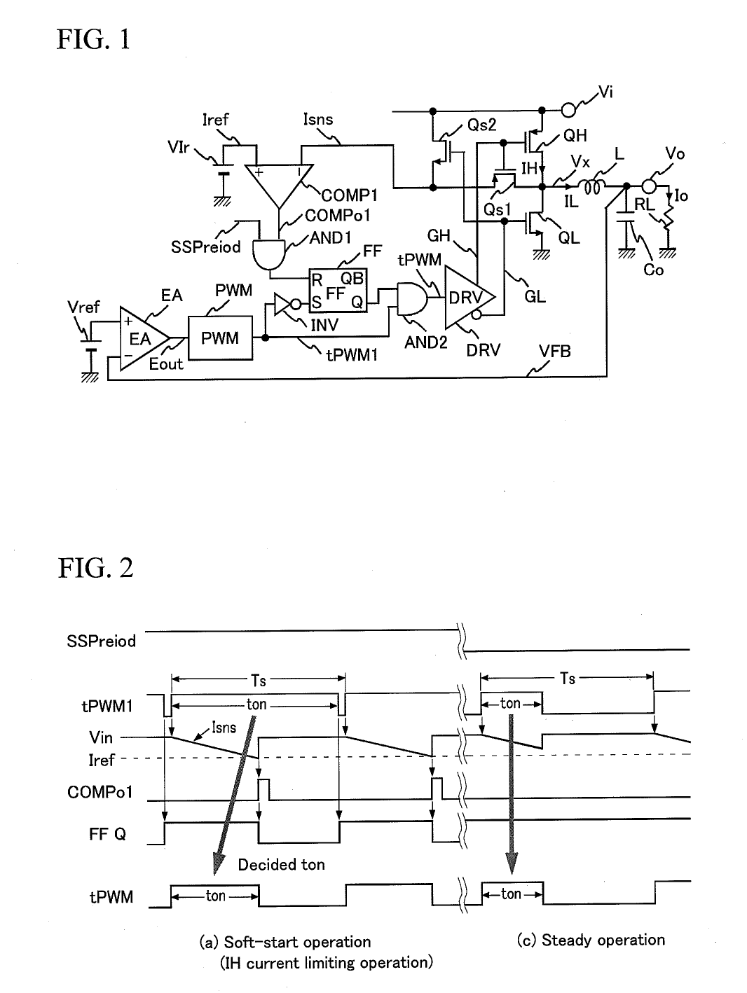

FIG. 1 is a diagram showing the schematic structure of a power-supply device according to a first embodiment of the present invention. In FIG. 1, Vi denotes an input terminal and Vo denotes an output terminal. An upper side power MOSFET QH is connected to the input terminal Vi. A lower side power MOSFET QL is connected to a ground potential side. An LC smoothing filter as a power system output filter including an inductor L and a capacitor Co is connected to the midpoint of the power MOSFETs QH and QL. An output terminal Vo and one input (−) of an error amplifier EA are connected to the midpoint of the LC smoothing filter.

A reference voltage Vref is connected to another input (+) of the error amplifier EA. Gates of the power MOSFETs QH and QL are connected to an output of the error amplifier EA through a pulse-width modulation (abbreviated as PWM) oscillator PWM, an AND gate AND2, and a driver circuit DRV. The power MOSFETs QH and QL are driven in reversed phases and alternately conduct.

Next, the structure of a soft-start circuit is described. Switch MOSFETs Qa2 and Qs1 are connected between the input terminal Vi and the midpoint of the MOSFETs QH and QL. One input (−) of a comparator COMP1 is connected to the midpoint of the switch MOSFETs Qs2 and Qs1 (switches for lifting Isns to Vin). On the other hand, a predetermined specified voltage VIr is connected to the other input (+) of the comparator COMP1. An output of the comparator COMP1 is connected to one input R of a flip-flop FF via an AND gate AND1. An output Q of the flip-flop FF is connected to an AND gate AND2. An output of the pulse-width modulation type oscillator PWM is connected to another input S of the flip-flow FF via an inverter circuit INV. A signal SSPeriod for enabling an output signal COMPo1 of the comparator COMP1 only in a period from the end of a UVL (Under Voltage Lockout) period until an output voltage Vout generated at the output terminal Vo rises to a desired (reference) voltage, i.e., a soft-start period is connected to the AND gate AND1 (a circuit for generating the signal SSPeriod is not shown in the figure). Gates of the power MOSFET QH and the switch MOSFET Qs1 are connected and gates of the power MOSFET QL and the switch MOSFET Qs2 are connected. The power MOSFET QH and the switch MOSFET Qs1 are driven at the same timing and the power MOSFET QL and the switch MOSFET Qs2 are driven at the same timing. The signal SSPeriod is generated by comparing Vo and Vref with a not-shown comparator and generated as a signal indicating whether it is a soft-start operation period.

### (2) Circuit Operation

Subsequently, a circuit operation of the power-supply device shown in FIG. 1 is explained. First, in a steady operation of a buck converter, an input voltage applied to the input terminal Vi is converted into a voltage via the LC smoothing filter according to on-off control of the upper side power MOSFET QH and the lower side power MOSFET QL. This converted voltage VFB is compared with the reference voltage Vref by the error amplifier EA. An error voltage is amplified and generated at the output of the error amplifier EA. This error voltage is converted into a PWM pulse by the pulse-width modulation type oscillator PWM. This PWM pulse is converted into an on-off time ratio (duty: α) for driving the upper side power MOSFET QH and the lower side power MOSFET QL with the driver circuit DRV and subjected to negative feedback control to reduce the error voltage to zero. The converted voltage VFB is equal to the reference voltage Vref. In this case, the converted voltage VFB obtained through the LC smoothing filter in a steady state, i.e., an output voltage Vout obtained at the output terminal Vo is proportional to the duty α of an input voltage Vin applied to the input terminal Vi.

Therefore, a relational expression Vout=VFB=Vref=α*Vin holds. Here, since the duty α is defined by on time/(sum of on time and off time), the duty α takes a value between 0 and 1.

Since the duty α is equal to a voltage conversion ratio, the duty α can also be represented by a ratio of the output voltage Vout and the input voltage Vin (Vout/Vin). Therefore, a desired voltage proportional to the duty α of the input voltage Vin is obtained as the output voltage Vout at the output of the LC smoothing filter, i.e., the output terminal Vo. In this case, an electric current flowing to the inductor L, i.e., an inductor current IL has a waveform formed by superimposing a change current decided by the input voltage Vin, the output voltage Vout, a value L of the inductor L, and a switching period Ts (an inverse number of a switching frequency) on a DC component of an output (load) current. When a change current ΔIL(on) at on time of the upper side power MOSFET QH increases, a magnitude of this change current is calculated by ΔIL(on)=(Vin-Vout)/L*Ts*(Vout/Vin)=(Vin−Vout)/L*Ts*α. When a change current ΔIL(off) at off time of the upper side power MOSFET QH decreases, the magnitude is calculated by ΔIL(off)=Vout/L*Ts*(1−Vout/Vin)=Vout/L*Ts*(1−α). Therefore, in the steady state, since ΔIL(on)=ΔIL(off) holds, a width of this increase and decrease is an amplitude of a change current of the inductor current IL.

Next, a soft-start operation in a power supply start mode is explained with reference to FIG. 2 showing operation timing. In the power supply start mode, since the converted voltage VFB obtained through the LC smoothing filter, i.e., the output voltage Vout obtained at the output terminal Vo starts from a zero voltage, a large deviation occurs between the converted voltage VFB and the reference voltage Vref compared by the error amplifier EA. Therefore, to rapidly bring the output voltage Vout close to the reference voltage Vref, a large error voltage is amplified and generated at the output of the error amplifier EA (ordinarily, this error voltage reaches a power supply voltage). An output of the pulse-width modulation type oscillator PWM converted according to this error voltage, i.e., a PWM pulse tPWM1 is a pulse, the duty α of which is close to 1 (ordinarily, the duty α is limited not to be equal to or larger than 1. See an operation waveform tPWM1 shown in FIG. 2). The upper side power MOSFET QH and the lower side power MOSFET QL are driven by the PWM pulse tPWM1 via the driver circuit DRV. In this case, when the change current ΔIL(on) at on time of the upper side MOSFET QH increases, since α≈1 from the relation of ΔIL(on)=Vin/L*Ts*α, ΔIL(on) is an extremely large current. It is likely that an electric current that breaks the upper side power MOSFET QH flows. Therefore, the soft-start operation for smoothly raising the output voltage Vout obtained at the output terminal Vo while preventing the electric current from flowing is necessary.

In this embodiment, in the PWM pulse tPWM1, the duty α of which is close to 1 as shown in FIG. 2, first, the flip-flop FF is set at off time of the PWM pulse tPWM1. At a point when the PWM pulse tPWM1 enters an on period ton (=(Vo/Vin)*Ts), the PWM pulse tPWM for driving the upper side power MOSFET QH is turned on. Simultaneously with turning on the PWM pulse tPWM, the switch MOSFET Qs1 is also turned on.

Next, an electric current IH flowing at this on time is changed to a form of an on voltage of the upper side power MOSFET QH and detected as a node voltage Isns. The node voltage Isns and a specified value Iref are compared by the comparator COMP1. When the voltage Isns falls below the specified value Iref as shown in FIG. 2, the output signal COMPo1 of the comparator COMP1 is switched to “High”. In order to reset the flip-flop FF with this “High” signal, an on-pulse width ton of the PWM pulse tPWM for driving the upper side power MOSFET QH is finally decided by passing a signal obtained at the output Q of the flip-flop FF and an output of the pulse-width modulation type oscillator PWM (i.e., PWM pulse tPWM1) through the AND gate AND2. Consequently, the upper side power MOSFET QH is turned off and the lower side power MOSFET QL is turned on. Therefore, the switching MOSFET Qs1 and Qs2 are also turned on and off, respectively, in association with the turning off and on of the power MOSFETs QH and QL. Consequently, the node voltage Isns is returned to the side of the input voltage Vin given to the input terminal Vi and the output COMPo1 of the comparator COMP1 is inverted and returns to the previous level (“High” to “Low”).

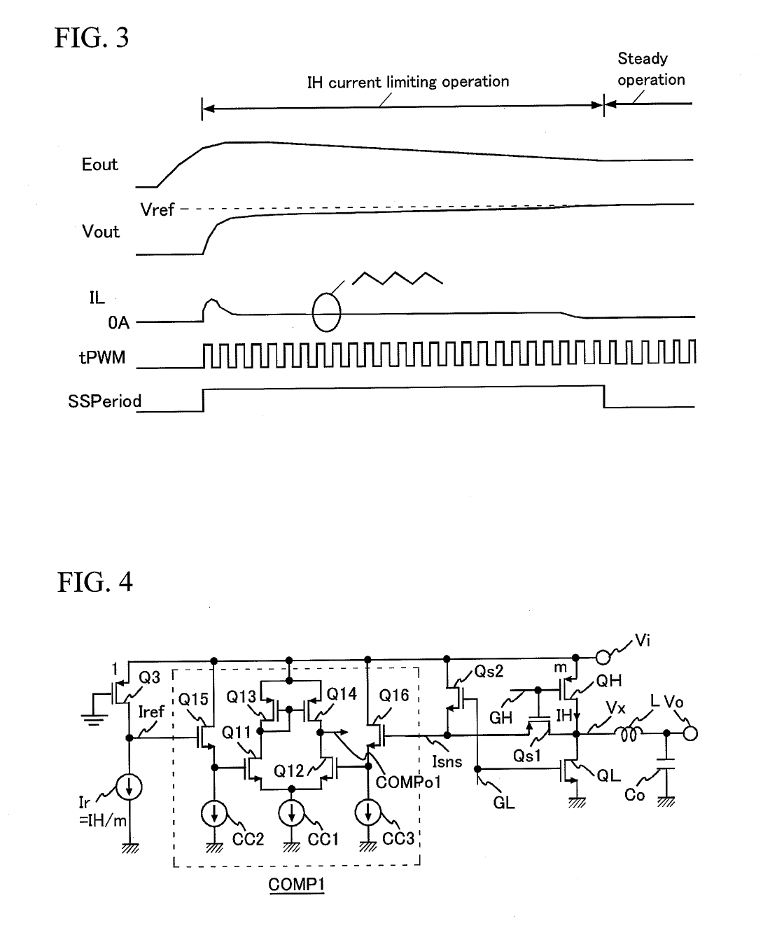

This operation (an operation indicated by (a) in FIG. 2) is repeated at every switching period Ts and continued until the converted voltage VFB, i.e., the output voltage Vout obtained at the output terminal Vo rises to the reference voltage Vref. In other words, a signal for forcing to turn off the upper side power MOSFET QH is created by detecting an electric current according to this operation. An electric current to an electric current that does not break the upper side power MOSFET QH to gradually and smoothly raise the output voltage Vout obtained at the output terminal Vo from a zero voltage to a voltage set as the reference voltage Vref as shown in FIG. 3. It can be said that this soft-start period is an IH current limiting operation period shown in FIG. 3. It is possible to enter a steady operation after repeating this IH current limiting operation (the operation indicated by (a) in FIG. 2) and raising an output voltage. Therefore, there is an effect that it is possible to realize an appropriate soft-start operation without using the soft-start capacitor in the past. Since the soft-start capacitor is unnecessary, there is an effect that a reduction in size and a reduction in cost of a system and a unit can be realized.

### (3) Structure of the Comparator COMP1

FIG. 4 is a diagram showing the specific structure of the comparator COMP1 used for the current detection shown in FIG. 1 at the time when the comparator COMP1 is formed by a MOSFET. Electric potentials of the specified voltage Iref converted into a voltage for current detection and the node voltage Isns extremely shift to the input voltage Vin side. Therefore, the specified voltage Iref for current detection can be realized by connecting a level shift circuit including a MOSFET Q15 and a constant current source CC2 to a differential pair circuit including MOSFETs Q11 to Q14 and a constant current source CC1 though a level shift circuit including a MOSFET Q16 and a constant current source CC3 on the node voltage Isns side and outputting the output signal COMPo1 from the midpoint of the MOSFETs Q12 and Q14.

Since an operation of the comparator COMP1 is designed such that the output signal COMPo1 is switched from “Low” to “High” when the node voltage Isns falls below the specified voltage Iref for current detection, it is seen that a signal waveform of the output signal COMPo1 shown in FIG. 2 is obtained. When a signal amplitude obtained at the output COMPo1 of the comparator COMP1 is small, although not shown in the figure, for signal amplitude amplification, a comparator or the like of a CMOS inverter two-stage structure or a cascade structure of a drain common circuit and one stage of a CMOS inverter may be applied to the output of the differential pair circuit.

In FIG. 4, the generation of the specified voltage Iref is realized by a MOSFET Q3 and a constant current source Ir instead of a voltage source VIr. As an effect of this, when the upper side power MOSFET QH and the MOSFET Q3 are arranged close to each other in a same process and on a same chip, by setting MOS sizes of the MOSFETs to m:1, it is possible to equally set an on-voltage generated when an electric current 1/m of the electric current IH of the upper side power MOSFET QH is fed to the MOSFET Q3 and an on-voltage generated when the current IH is fed to the upper side power MOSFET QH. Consequently, accuracy of current detection is improved.

Moreover, as another effect, since these MOSFETs are arranged close to each other on the same chip, it is possible to equally set on-voltage drop of the MOSFETs because both the MOSFETs are affected the same even if process variation occurs in an on-resistance of the power MOSFET. Therefore, if the current value defined by the upper side power MOSFET QH is set as IH and the current 1/m of the current value IH is set to the constant current source Ir, the specified voltage Iref obtained at the output of the MOSFET Q3 and the node voltage Isns generated by the electric current flowing to the upper side power MOSFET QH can be compared by the comparator COMP1.

### (4) Structure of the Pulse-Width Modulation Type Oscillator

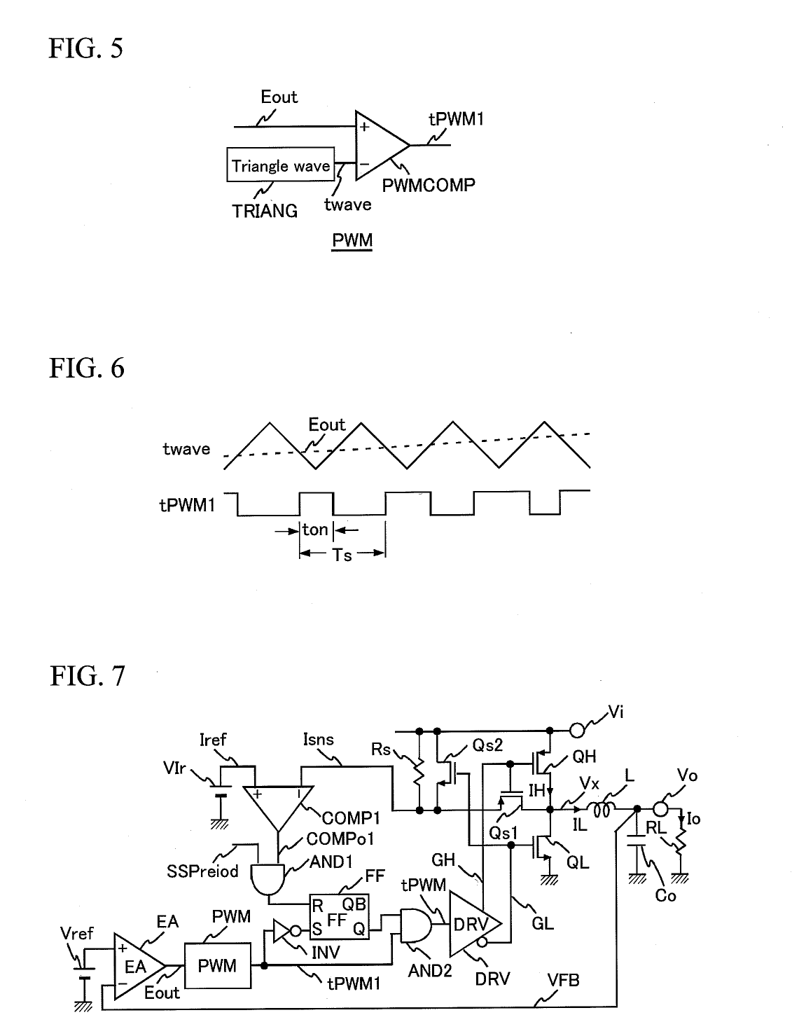

FIG. 5 is a diagram showing the specific structure of the pulse-width modulation type oscillator PWM shown in FIG. 1. In an example shown in FIG. 5, the pulse-width modulation type oscillator PWM includes a saw-tooth oscillator TRIANG and a PWM comparator PWMCOMP. As shown in FIG. 6, a PWM pulse tPWM1 is obtained at an output of the comparator PWMCOMP by comparing a triangle wave output waveform twave of the saw-tooth oscillator TRIANG and an output voltage Eout of the error amplifier EA with the PWM comparator PWMCOMP. As the PWM pulse tPWM1, a wider on-pulse width is generated as the output voltage Eout of the error amplifier EA increases. Ordinarily, although not shown in the figure, a contrivance is applied to a circuit to prevent the on-pulse width of the PWM pulse from increasing to be equal to or larger than 100%.

### Second Embodiment

FIG. 7 is a diagram showing a schematic circuit configuration of a power-supply device according to a second embodiment of the present invention. In FIG. 7, components same as those shown in FIG. 1 are denoted by the same reference numerals and signs. A circuit shown in FIG. 7 is different from that shown in FIG. 1 in that a resistance Rs is connected in parallel to the switch MOSFET Qs2. With such a configuration, the node voltage Isns is connected to the input voltage Vin, which is given to the input terminal Vi, via the resistance Rs when both the switch MOSFETs Qs1 and Qs2 are off. Therefore, it is possible to always decide a potential of the node voltage Isns regardless of operation timings of the switches, the node voltage Isns is less likely to be affected by disturbances such as noise, and it is possible to prevent malfunction of the comparator COMP1. In other words, the resistance Rs has an action for deciding a (−) electric potential of the comparator COMP1 during dead time of the switch Qs2. With this method, there is a further noise rejection effect and effects same as those in the example of the structure shown in FIG. 1 are obtained.

### Third Embodiment

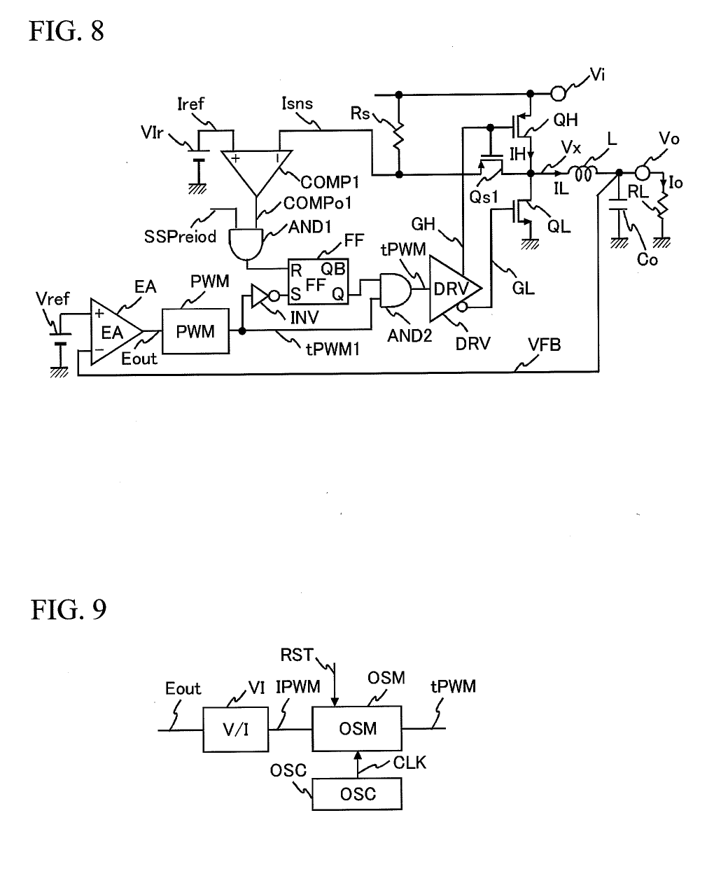

FIG. 8 is a diagram showing a schematic circuit configuration of a power-supply device according to a third embodiment of the present invention. A circuit shown in FIG. 8 is different from that shown in FIG. 7 in that the switch MOSFET Qs2 is removed and only resistance Rs is provided. This is because, except a period in which the switch MOSFET Qs 1 is on in FIG. 7, as long as the node voltage Isns is always connected the input voltage Vin, which is given to the input terminal Vi, via the resistance Rs, the comparator COMP1 does not malfunction. Consequently, it is possible to remove the switch MOSFET Qs2. With such a configuration, effects same as those in the first and second embodiments can be obtained.

### Fourth Embodiment

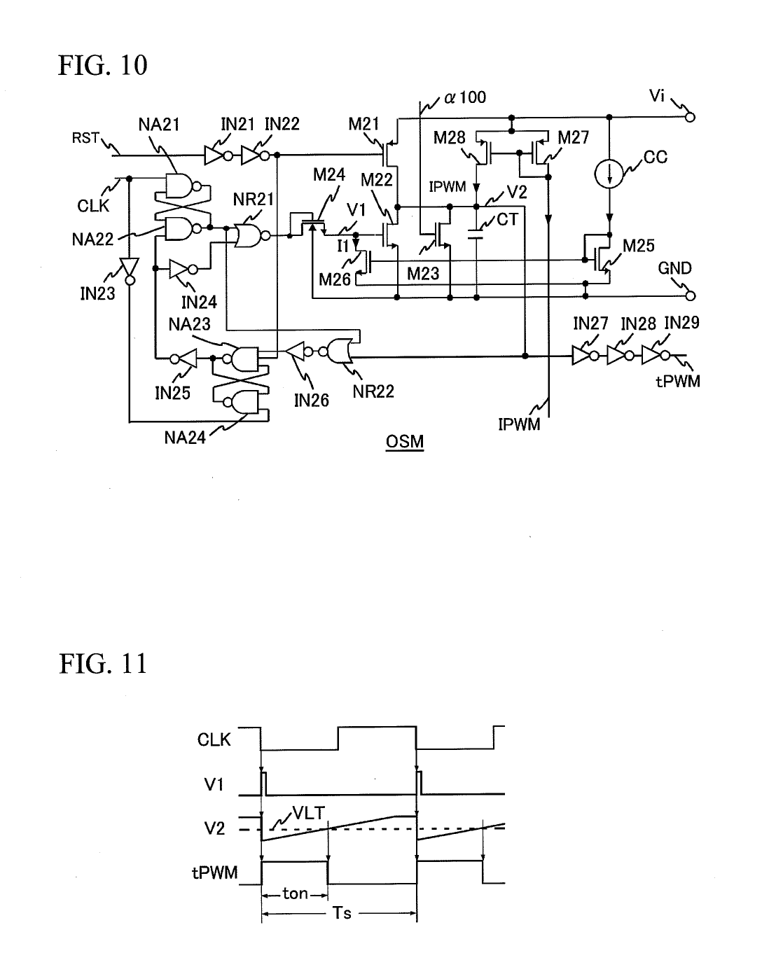

FIG. 9 is a diagram showing a specific example of the structure of a pulse-width modulation type oscillator PWM used in a power-supply device according to a fourth embodiment of the present invention. The pulse-width modulation type oscillator PWM shown in FIG. 9 includes a one-shot multivibrator OSM, an oscillator OSC, and a V/I converter VI. Moreover, a specific example of the detailed structure of the one-shotmultivibrator OSM is shown in FIG. 10. As an operation of the one-shotmultivibrator OSM, as shown in FIG. 11, a fine pulse is generated in a terminal voltage V1 in the one-shotmultivibrator OS shown in FIG. 10 in a fall waveform of an output waveform CLK of the oscillator OSC and a MOS M22 is turned on by the generated pulse to set a terminal voltage V2 of a capacitor CT to a ground potential.

Then, on-time of the PWM pulse tPWM is set at this timing. The terminal voltage V2 of the capacitor CT is raised by an electric current IPWM obtained by converting the output voltage Eout of the error amplifier EA with the V/I converter VI. When the terminal voltage V2 of the capacitor CT reaches a logic threshold voltage VLT of an inverter IN27, a polarity of the inverter IN27 is inverted. Therefore, an on-pulse width of the PWM pulse tPWM is decided. In this way, an output voltage of the error amplifier EA can be converted into an electric current and, then, converted into the PWM pulse tPWM. Therefore, it is possible to generate a PWM pulse in the same manner as the embodiment shown in FIG. 5. Further details of the one-shotmultivibrator OSM are disclosed in, for example, JP Patent Publication (Kokai) No. 2002-232275.

FIG. 12 is a diagram showing a circuit configuration of a power-supply device to which the pulse-width modulation type oscillator shown in FIG. 9 is applied. The power-supply device shown in FIG. 12 is different from that shown in FIG. 1 in that the pulse-width modulation type oscillator shown in FIG. 9 includes an on-pulse width deciding function that has the flip-flop FF, the inverter INV, and the AND gate AND2 shown in FIG. 1. Therefore, by connecting the output of the AND gate AND1 to a reset terminal RST of the one-shotmultivibrator OSM, the flip-flop FF, the inverter INV, and the AND gate AND2 can be removed. In this embodiment, it is possible to realize a soft-start operation same as that shown in FIG. 1.

### Fifth Embodiment

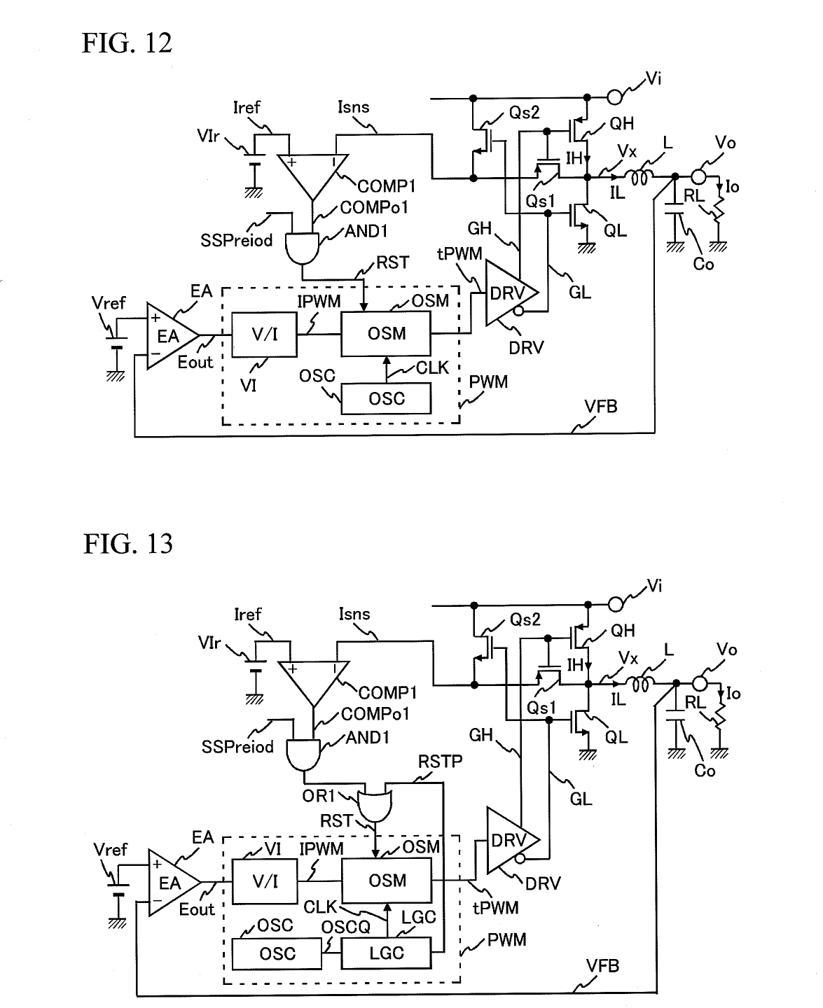

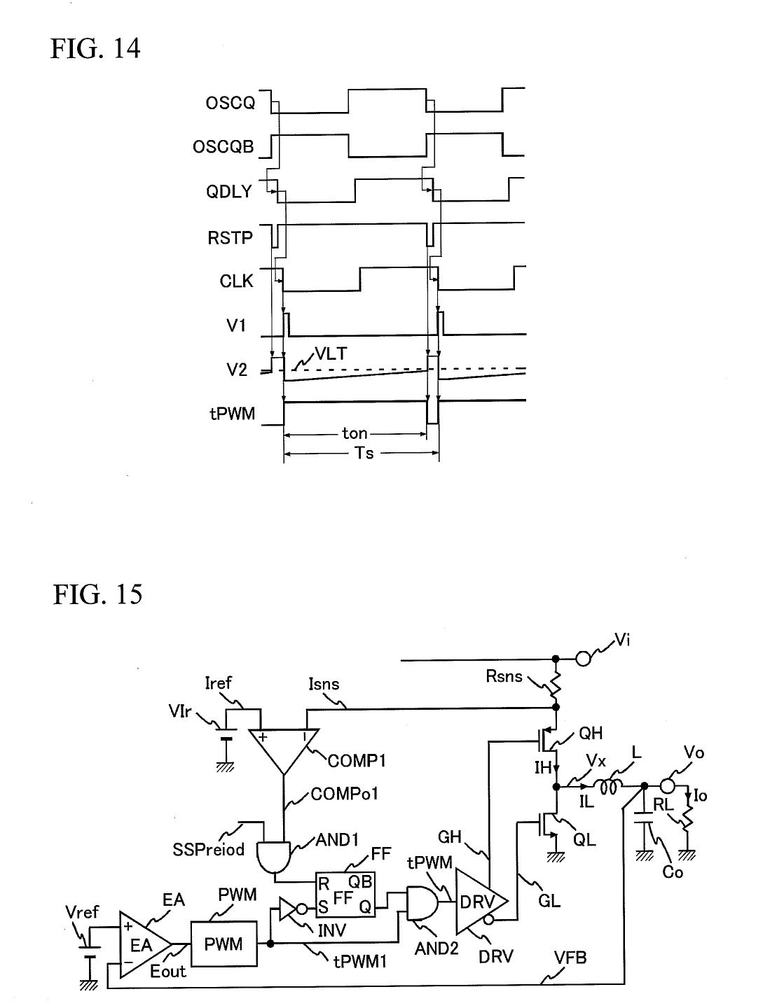

FIG. 13 is a diagram showing a schematic circuit configuration of a power-supply device according to a fifth embodiment of the present invention. The power-supply device shown in FIG. 13 is different from that shown in FIG. 12 in that a logic circuit LGC is provided at an output of the oscillator OSC and the logic circuit LGC generates a clock pulse CLK and a reset pulse RSTP shown in FIG. 14 from an output signal OSCQ of the oscillator OSC.

The clock pulse CLK is used at timing when an on-pulse width of the PWM pulse tPWM, which is an output signal of the one-shotmultivibrator OSM is set. The reset pulse RSTP is used at timing when the one-shotmultivibrator OSM is reset in every cycle in a switching operation. Consequently, an off-period is provided in the PWM pulse tPWM that is always obtained even if the terminal voltage of the capacitor CT shown in FIG. 10 does not exceed the logic threshold voltage VLT as shown in FIG. 14. In this embodiment, it is possible to realize a soft-start operation same as that shown in FIG. 1.

### Sixth Embodiment

FIG. 15 is a diagram showing a schematic circuit configuration of a power-supply device according to a sixth embodiment of the present invention. As shown in FIG. 15, rather than detecting the electric current IH flowing to the upper side power MOSFET shown in FIG. 1 with the on-resistance of the upper side power MOSFET, the electric current IH is detected by a sense resistance Rsns provided anew between the input terminal Vi and a source electrode of the upper side power MOSFET. It is possible to detect the electric current IH in the same manner as the embodiments described above. Besides, various current detecting methods used in a power supply such as methods of detecting an electric current using a current transformer, a hall element, and the like can be applied.

### Seventh Embodiment

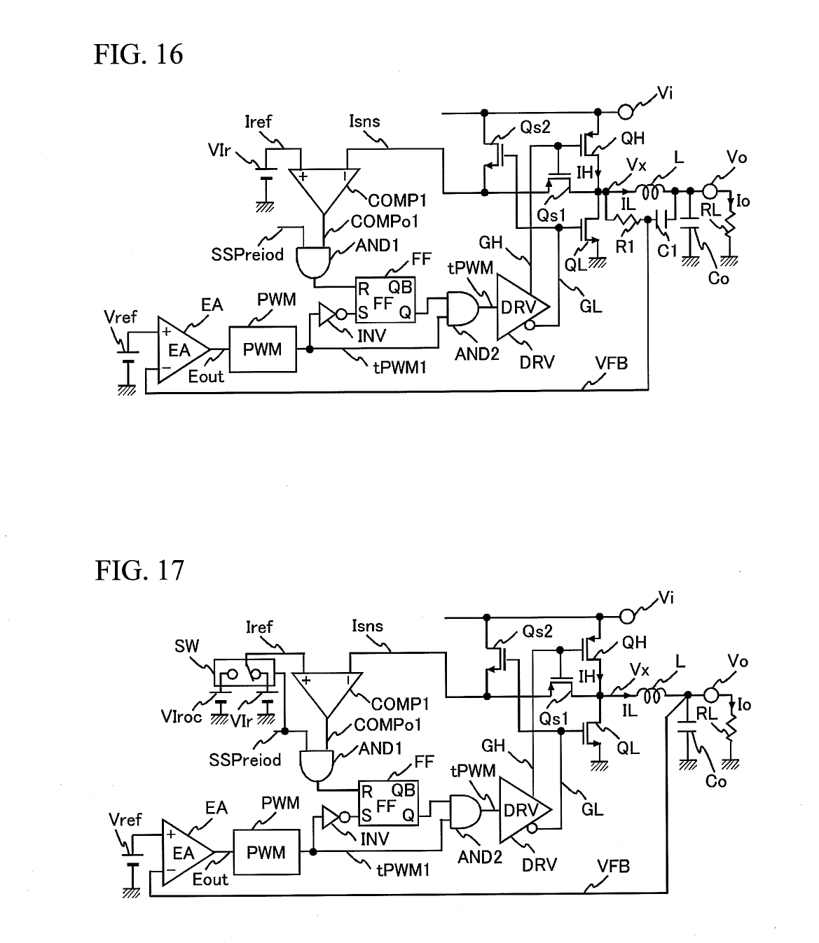

FIG. 16 is a diagram related to a seventh embodiment of the present invention and showing the structure in which the structure shown in FIG. 1 is applied to a first-order feedback control power supply system disclosed in JP Patent Publication (Kokai) No. 2004-080985. As shown in FIG. 16, a soft-start method and a soft-start circuit are applicable even when an electric current is fed back from the midpoint of a serial circuit including a resistance R1 and a capacitor C1 provided at both ends of an inductor L to a (−) input of the error amplifier EA.

### Eighth Embodiment

FIG. 17 is a diagram related to an eight embodiment of the present invention and showing an example of the structure of a power-supply device in which over current detection is also used for current detection of a soft-start method and a soft-start circuit. The structure shown in FIG. 17 is different from that shown in FIG. 1 in that, besides the specified voltage VIr for soft-start, a specified voltage VIroc (>VIr) for over current detection is provided and the specified voltages VIr and VIroc are connected to an input (+) of the comparator COMP1 via a changeover switch SW. At a point when a soft-start operation period ends, connection of a specified voltage to the input (+) of the comparator COMP1 is switched from the specified voltage for soft-start to the specified voltage VIroc for over current detection. Consequently, since the power-supply device operates regarding that a magnitude of the electric current IH is an over current during a steady operation, it is possible to obtain an over current detection signal at the output COMPo1 of the comparator COMP1. Therefore, it is possible to realize the soft-start operation and the over current detection operation with a common circuit.

### Ninth Embodiment

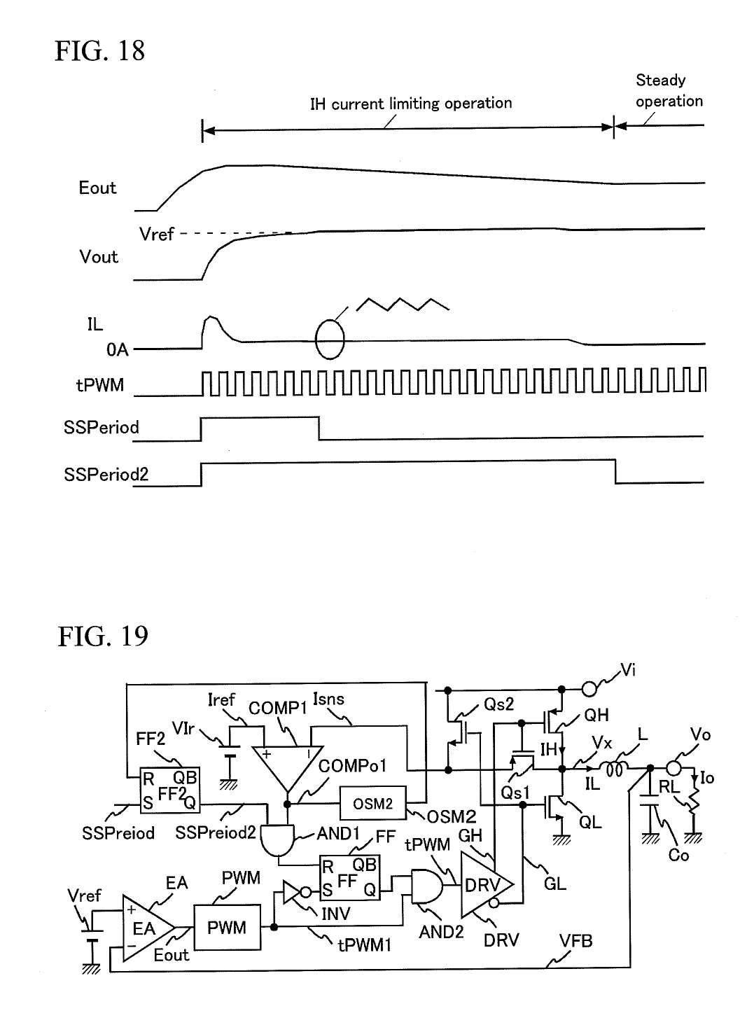

Subsequently, an example in which a soft-start operation is different depending on a level of a setting value of the specified voltage VIr. In the embodiments described above, as indicated by the operation waveform shown in FIG. 3, the soft-start operation ends in the soft-start period SSPeriod. However, in some case, the soft-start operation does not end as indicated by an operation waveform shown in FIG. 18.

The soft-start operation is not completed as shown in FIG. 18 when, although the output voltage Vout obtained at the output terminal Vi has risen to the desired reference voltage Vref in the soft-start period SSPeriod, the output voltage Eout of the error amplifier EA has not stabilized to a voltage at steady time, is still high, and has not converged. In other words, the soft-start operation is not completed when, even if the soft-start period ends, the error amplifier EA still recognizes that it is the soft-start period and drives the upper side power MOSFET with the PWM pulse tPWM wider than an on-pulse width at steady time. Therefore, a power-supply device regards the output voltage Vout lower side than a predetermined voltage and acts to further increase the output voltage Vout. Therefore, the power-supply device feeds a large inductor current IL (an inductor current at the on-time of the upper side power MOSFET is equivalent to the electric current IH of the upper side power MOSFET). A method of preventing this situation is described below.

FIG. 19 is a diagram showing a schematic circuit configuration of a power-supply device according to a ninth embodiment of the present invention. With a circuit shown in FIG. 19, when the electric current IH larger than an electric current equivalent to the specified voltage Iref flows even after the soft-start period SSPeriod, the soft-start period is extended while a pulse generated at the output of the comparator COMP1 is continuously generated.

In FIG. 19, one-shotmultivibrator OSM2 and a flip-flop FF2 are provided at the output of the comparator COMP1 and connected to one input (an input to which the signal SSPeriod has been connected) of the AND gate AND1. Consequently, when the flip-flop FF2 is reset by the signal in the soft-start period SSPeriod to start the soft-start period, the soft-start period can be extended until the flip-flop FF2 is reset by an output of the one-shot multivibrator OSM2 (FIG. 10 is applicable). In other words, in the one-shot multivibrator OSM2, while a continuous pulse is generated at the output COMPo1 of the comparator COMP1, the continuous pulse is inputted to a clock terminal CLK of the one-shotmultivibrator OSM2. Therefore, a state in which the terminal voltage V2 of the capacitor CT shown in FIG. 10 does not exceed the logic threshold voltage VLT of the inverter IN27 is maintained and on-time is continued. This period is a period in which soft-start can be extended. Although this effective period is not shown in the figure, it is possible to continue the on-time by connecting an output of the flip-flop FF2 to a reset terminal of the one-shot multivibrator OSM2. In on-time setting in the one-shotmultivibrator OSM2, it is easy to continue the on-time if an integration time constant is set to be equal to or larger than three times of a switching period Ts. Consequently, it is possible to smoothly shift the output voltage Vout obtained at the output terminal Vo to a steady operation as shown in FIG. 3 in the same manner as shown in FIG. 1.

### Tenth Embodiment

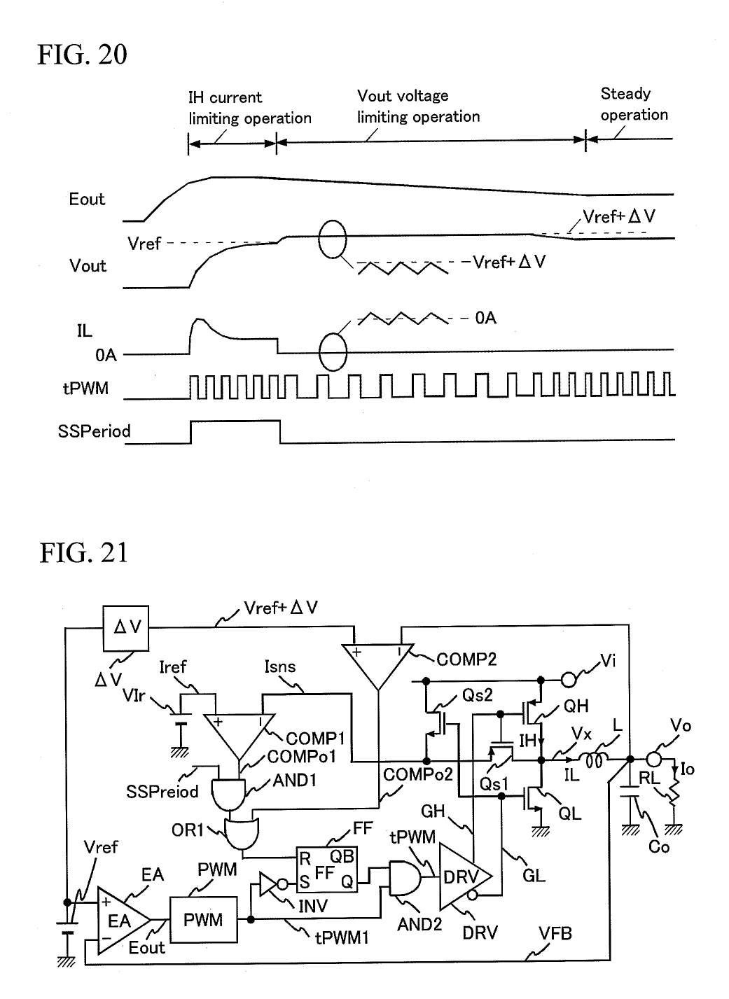

A tenth embodiment of the present invention relates to a method of smoothly shifting the output voltage Vout by providing a Vout (output) voltage limiting operation following an IH current limiting operation as indicated by an operation waveform shown in FIG. 20.

FIG. 21 is a diagram showing a schematic circuit configuration of a power-supply device according to the tenth embodiment. FIG. 20 shows a specific example of the structure including this operation on the basis of FIG. 1.

In FIG. 21, the Vout voltage limiting operation is realized by configuring a circuit with a comparator COMP2, an OR gate OR1, and a ΔV generating circuit ΔV. An operation of the circuit is controlled in view of the fact that, in a steady state, the output voltage Vout obtained at the output terminal Vo is equal to the reference voltage Vref. In other words, a voltage Vref+ΔV generated by adding a voltage ΔV to the reference voltage Vref with the ΔV generating circuit ΔV and the output voltage Vout obtained at the output terminal Vo are compared by the comparator COMP2. The flip-flop FF is reset via the OR gate OR1 by an output signal COMPo2 of the comparator COMP2 obtained when the output voltage Vout exceeds the voltage Vref+ΔV. Consequently, an on-width of the PWM pulse tPWM during the Vout voltage limiting operation is decided.

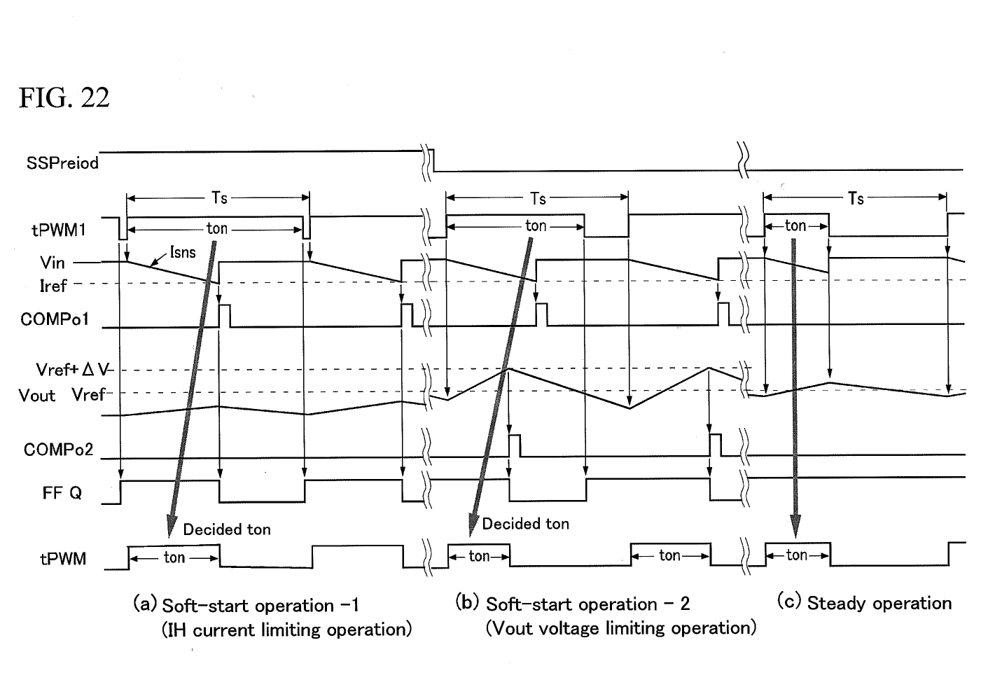

(b) in FIG. 22 shows an operation waveform in which a Vout voltage limiting operation corresponds to the operation described above. It is seen from (b) in FIG. 22 that, as shown in FIG. 20, this operation is repeated until the output voltage Eout of the error amplifier EA converges to a voltage state of a steady operation and, then, the operation shifts to the steady operation.

It is desirable that a ΔV voltage setting width of the ΔV generating circuit in the Vout voltage limiting operation used here is set in an allowable voltage range of the output voltage Vout obtained at the output terminal Vo. Usually, ΔV is about 20 mV to 30 mV.

### Eleventh Embodiment

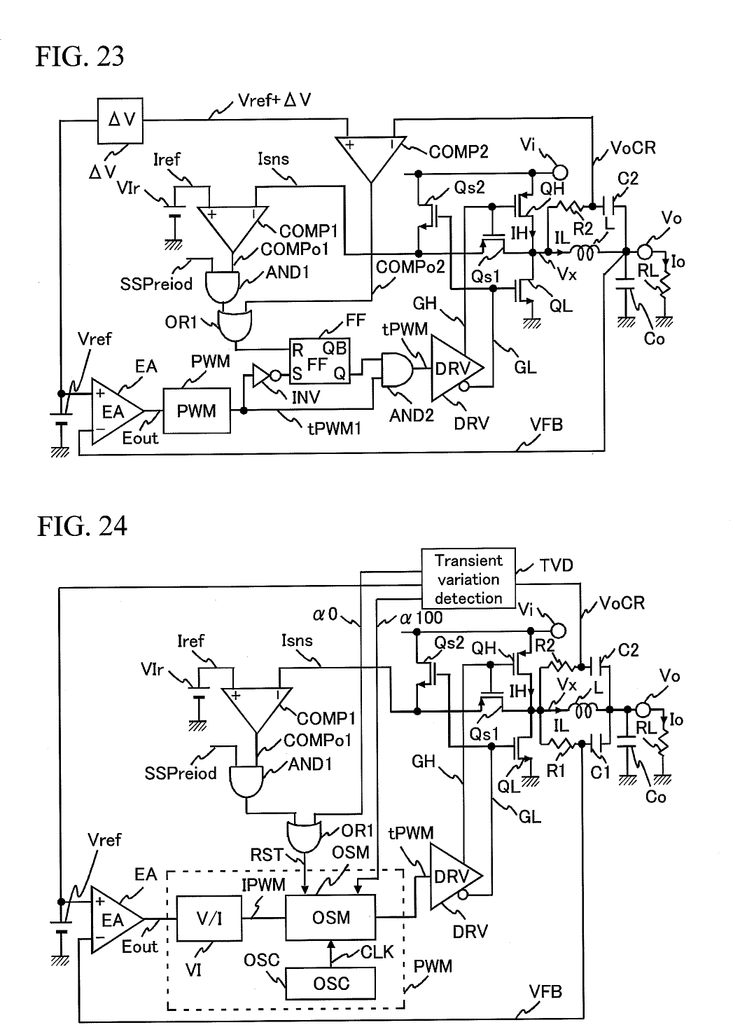

FIG. 23 is a diagram showing a schematic circuit configuration of a power-supply device according to an eleventh embodiment of the present invention and is equivalent to a modification of FIG. 21. The power-supply device shown in FIG. 23 is different from that shown in FIG. 21 in that a midpoint voltage VoCR of a serial circuit including a resistance R2 and a capacitor C2 provided at both ends of the inductor L is used instead of the output voltage Vout obtained at the output terminal Vo given to an input (−) of the comparator COMP2. In this method, as in the method described above, a change in the output voltage Vout obtained at the output terminal Vo is reflected on the midpoint voltage VoCR, a soft-start operation including the Vout voltage limiting operation is possible in the same manner as shown in FIG. 21.

### Twelfth Embodiment

FIG. 24 is a diagram showing a schematic circuit configuration of a power-supply device according to a twelfth embodiment of the present invention and is equivalent to an example in which the configurations in FIGS. 23 and 9 are applied to the first-order feedback control power supply system disclosed in JP Patent Publication (Kokai) No. 2004-080985. A transient variation detection circuit TVD shown in FIG. 24 has a Vout voltage limiting operation function. Therefore, a soft-start operation including the Vout operation limiting operation is possible in the same manner by outputting one output signal α0 of the transient variation detection circuit TVD to the OR gate OR1. It is desirable to set the other output signal α100 of the transient variation detection circuit TVD in an operation inhibition state during soft-start.

### Thirteenth Embodiment

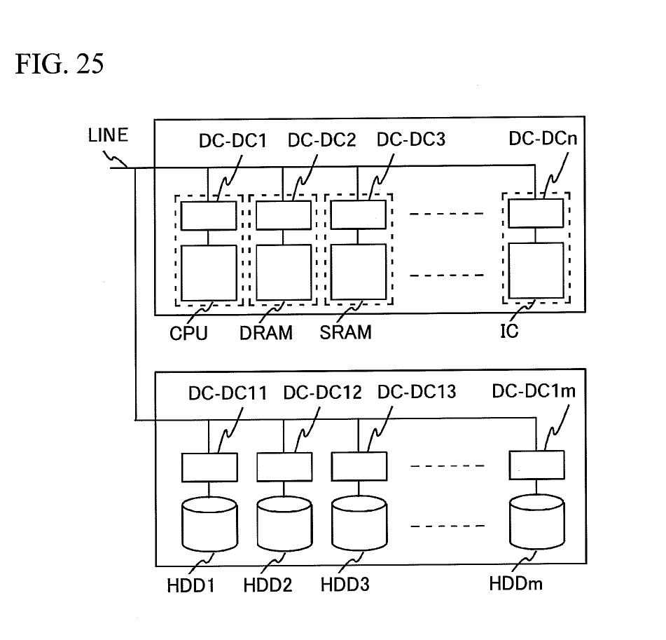

FIG. 25 is a diagram showing an example in which the power-supply devices according to the first to sixth embodiments of the present invention is applied to an HDD (Hard Disk Drive) device. In the HDD device, DC-DC converters DC-DC1 to DC-DCn, which are the power-supply devices according to the first to sixth embodiments, supply electric power of suitable voltages different for respective objects to a board including a processor CPU that manages control for storing data in the HDD device, a high-speed large-capacity memory DRAM, and an SRAM. As the DC-DC converters DC-DC1 to DC-DCn as the power-supply devices shown in FIG. 25, a single-phase power-supply device and a multi-phase power-supply device are used according to ampacities of the processor CPU, the high-speed large-capacity memory DRAM, the SRAM, and the like to which electric power is supplied. Power-supply devices DC-DC11 to DC-DC1m different from those of the present invention are applied to HDD devices HDD1 to HDDm.

### Fourteenth Embodiment

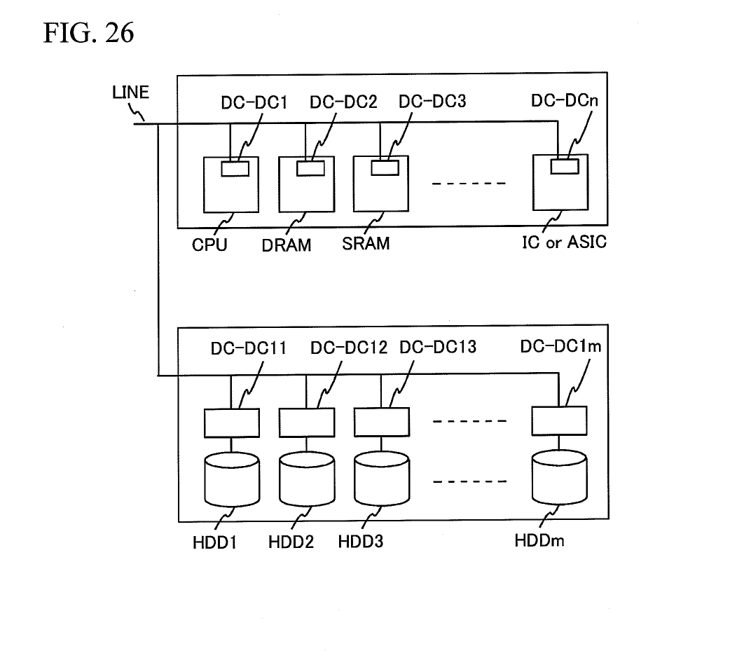

FIG. 26 is a diagram showing the structure for mounting the DC-DC converters DC-DC1 to DC-DCn, which are the power-supply devices according to the first to twelfth embodiments of the present invention, on a chip or a package same as a chop or a package on which a processor CPU that manages control for storing data in an HDD device, a high-speed large-capacity memory DRAM, an SRAM, and the like are mounted and supplying electric power of suitable voltages different for respective objects to the chip or the package. By mounting the DC-DC converters DC-DC1 to DC-DCn in this way, it is possible to reduce the number of components mounted on the DC-DC converters and the processor CPU, the high-speed large-capacity memory DRAM, the SRAM, and the like as loads. Therefore, there is an effect in a reduction of size and a reduction in cost of a system and a unit.

Although not shown in the figure, it is also conceivable to form the DC-DC converters DC-DC1 to DC-DCn as an IC (on-chip) and mount the IC on a package same as a package on which the processor CPU that manages control for storing data in the HDD device, the large-capacity memory DRAM, the SRAM, and the like are mounted. There is also an effect in a reduction in size and a reduction in cost of a system and a unit.

### Others

In the above explanation, the power MOSFET is explained as an example of a semiconductor switching component. However, other power switching components such as an IGBT, a GaN device, and an SiC (Silicon Carbide) device may be used instead of the power MOSFET as long as the power switching components have an on-board structure.

If the power-supply device is mounted on (built in) a chip or a package same as a chip or a package on which the processor CPU, the high-speed large-capacity memory DRAM, the SRAM, and the like are mounted, as the semiconductor switching component, a switching component of, for example, a CMOS device manufactured in a process same as a process for the chip may be used.

A P-type semiconductor switching component is explained above as an example of an upper side semiconductor switching component. However, the upper side semiconductor switching component may be an N-type semiconductor switching component.

A buck DC-DC converter is explained above as an example of the power-supply device of the present invention. However, the power-supply device may be a boost type or a buck/boost type.

Moreover, the respective embodiments of the present invention have been explained on the basis of IH current detection means including the switch MOSFETs Qs1 and Qs2 shown in FIG. 1. However, it goes without saying that other IH current detection means can be applied in the same manner.

In the above explanation, as the converted voltage VFB fed back from the output terminal Vo to the error amplifier, an output voltage obtained at the output terminal Vo is directly fed back. However, in some case, a voltage obtained by dividing the output voltage obtained at the output terminal Vo may be used as the converted voltage VFB.

### CONCLUSION

The soft-start method and the soft-start circuit of the power-supply device of the present invention is also applicable to an isolation type DC-DC converter and is also applicable to applications of insulating DC-DC converters such as a single-transistor forward type converter, a two-transistor forward type converter, a push-pull type converter, a half bridge type converter, and a full bridge type converter.

Besides, it goes without saying that, although not shown in the figure, the soft-start method and the soft-start circuit of the power-supply device according to the first to twelfth embodiments can be applied and expanded to a DC-DC converter for a voltage regulator module (VRM) and portable equipment, a general-purpose DC-DC converter, and the like.

In the embodiments of the present invention, during soft-start, an electric current IH that flows to an upper side power semiconductor switching component of a pair of power semiconductor switching components of the power-supply device is detected and a reset signal is generated when the current IH increases to be larger than a predetermined specified current. An on-pulse width of a pulse outputted from a pulse-width modulation type oscillator is forced to be turned off in the middle. In response to this reset operation, an on-pulse width for driving the upper side power semiconductor switching component during final soft-start is decided. Consequently, external components for soft-start in the past can be made unnecessary. Therefore, it is possible to realize a reduction in cost and a reduction in size of a system and a unit. In future, when a high frequency switching operation at a frequency equal to or higher than 100 MHz of a power-supply device becomes possible and on-chip of an output LC smoothing filter is realized, a reduction of soft-start capacitors has an extremely large effect.

What is claimed is:

1. A power-supply device comprising:
a pair of power semiconductor switching components;
driving means for driving the pair of power semiconductor switching components;
a pulse-width modulation type oscillator that supplies a driving signal to the driving means;
an error amplifier that supplies an error signal indicating an error between a converted voltage and a reference voltage to the pulse-width modulation type oscillator;
current detection means for detecting an electric current IH flowing to an upper side power semiconductor switching component of the pair of power semiconductor switching components during soft-start;
reset means for forcing to reset an on-pulse width, which is outputted from the pulse-width modulation type oscillator, in the middle with a signal generated when the electric current IH increases to be larger than a predetermined specified current; and
on-pulse width decision means for deciding, in response to a reset operation of the reset means, an on-pulse width for driving the upper side power semiconductor switching component during final soft-start.

2. The power-supply device according to claim 1, wherein
the current detection means detects the electric current IH in a form of an on-voltage of the upper side power semiconductor switching component,
the reset means includes:
a first comparator that compares a node voltage Isns of the upper side power semiconductor switching component detected by the current detection means and a specified voltage Iref obtained by converting the predetermined specified current into a form of a voltage; and
a first AND gate that enables an output of the first comparator only in a soft-start period, and
the on-pulse width decision means includes:
a flip-flop that is set by an inverting signal (an off-pulse for driving the upper side power semiconductor switching component) of an output pulse of the pulse-width modulation type oscillator and reset by an output of the first AND gate (an output signal obtained when an output of the first comparator is node voltage Isns>specified voltage Iref); and
a second AND gate having an output of the flip-flop and an output of the pulse-width modulation type oscillator as inputs.

3. The power-supply device according to claim 1, wherein the pulse-width modulation type oscillator includes a saw-tooth oscillator and a PWM comparator.

4. The power-supply device according to claim 2, wherein
the current detection means has two switch elements connected in series between a midpoint of the pair of power semiconductor switching components and the other end of the upper power semiconductor switching component,
a first switch connected to the midpoint of the pair of power semiconductor switching components is driven at same timing as the upper side power semiconductor switching component, and
a second switch connected to the other end of the upper side power semiconductor switching component is driven at timing same as a lower side power semiconductor switching component.

5. The power-supply device according to claim 2, wherein the upper side power semiconductor switching component and a power semiconductor switching component that sets the predetermined specified voltage are mounted on a same chip.

6. The power-supply device according to claim 2, wherein the comparator includes a pair of level-shift circuits and a differential pair circuit.

7. The power-supply device according to claim 4, further comprising resistances inserted at both ends of the second switch connected to the other end of the upper side power semiconductor switching component.

8. The power-supply device according to claim 2, wherein
the current detecting means has a switch element between the midpoint of the pair of power semiconductor switching components and the first comparator,
the switch element is driven at same timing as the upper side power semiconductor switching component, and
the power-supply device further includes a resistance connected between the other end of the upper side power semiconductor switching component and the switch element.

9. The power-supply device according to claim 1, wherein
the pulse-width modulation type oscillator includes:
a voltage-current conversion circuit that converts an output voltage of the error amplifier into an electric current;
a one-shot multivibrator that sets an on-pulse width of a PWM pulse according to the electric current obtained by converting the voltage; and
an oscillator for giving a switching frequency to the one-shotmultivibrator, and
the power-supply device adopts structure in which on-pulse width decision means is omitted.

10. The power-supply device according to claim 9, further comprising:
a logic circuit that is provided between the oscillator and the one-shot multivibrator and generates a reset pulse and a new clock given to the one-shotmultivibrator on the basis of an clock output of the oscillator; and
an OR gate having the reset pulse and an output of the first AND gate as inputs, wherein
an output of the OR gate is supplied to a reset terminal of the one-shotmultivibrator.

11. The power-supply device according to claim 1, wherein the current detection means detects the electric current IH using a sense resistance inserted between the upper side power semiconductor switching component and an input terminal.

12. The power-supply device according to claim 1, further comprising
an LC smoothing filter connected to an output of the pair of power semiconductor switching components; and
a serial circuit including a first resistance and a first capacitor provided anew at both ends of L of the LC smoothing filter, wherein
the power-supply device feeds back an electric current from a midpoint of the serial circuit to the error amplifier.

13. The power-supply device according to claim 2, wherein the power-supply device is provided with a specified voltage for overcurrent detection in parallel to the predetermined specified voltage, switches the predetermined specified voltage to the specified voltage for overcurrent detection after end of a soft-start operation, and uses both the soft-start operation and an overcurrent detecting operation.

14. The power-supply device according to claim 2, wherein the power-supply device is further provided with a one-shot multivibrator and a flip-flop anew at the output of the first comparator and, even if an output of the power-supply device reaches a predetermined output voltage, continues a soft-start operation regarding that a period in which a pulse is generated at the output of the first comparator is a soft-start period.

15. The power-supply device according to claim 2, further comprising:
a ΔV generating circuit that generates a voltage ΔV in addition to the reference voltage;
a second comparator that compares an output of the ΔV generating circuit and an output of the power-supply device; and
an OR circuit having outputs of the second comparator and the first AND circuit as inputs.

16. The power-supply device according to claim 2, further comprising:
a ΔV generating circuit that generates a voltage ΔV in addition to the reference voltage;
an LC smoothing filter connected to an output of the pair of power semiconductor switching components;
a serial circuit including a resistance and a capacitor provided anew in parallel to L of the LC smoothing filter;
a second comparator that compares an output of the ΔV generating circuit and an output from a midpoint between the resistance and the capacitor in the serial circuit; and
an OR circuit having outputs of the second comparator and the first AND circuit as inputs.

17. The power-supply device according to claim 1, further comprising:
an LC smoothing filter connected to an output of the pair of power semiconductor switching components;
a first serial circuit including a first resistance and a first capacitor provided in parallel to L of the LC smoothing filter;
a second serial circuit including a second resistance and a second capacitor provided in parallel to L of the LC smoothing filter; and
a transient variation detection circuit that compares the reference voltage and an output from a midpoint between the second resistance and the second capacitor in the second serial circuit and detects transient variation, wherein
the power-supply device feeds back an electric current from a midpoint of the first serial circuit to the error amplifier, and
the power-supply device executes a soft-start operation using an output of the transient variation detection circuit.

18. An information processing apparatus comprising:
a power-supply device;
a CPU and a memory that receive supply of a DC voltage from the power-supply device; and
a hard disk device that stores information of the memory, wherein
the power-supply device includes:
an error amplifier that functions as a step-down DC-DC converter, which is inputted with a DC input voltage from an input terminal and outputs a stepped-down DC output voltage from an output terminal, and outputs a difference between a reference voltage and the DC output voltage as an error signal;
a pulse-width modulation type oscillator that subjects the output of the error amplifier to pulse width modulation;
a driving circuit that generates a driving signal from a pulse signal received from the pulse-width modulation type oscillator;
a pair of power semiconductor switching components that step down the DC input voltage on the basis of the driving signal from the driving circuit and generates the DC output voltage; and
a soft-start circuit that detects an electric current of the power semiconductor switching components and uses the electric current for a soft-start operation.

19. An IC circuit formed by integrating a power supply device including an error amplifier that functions as a step-down DC-DC converter, which is inputted with a DC input voltage from an input terminal and outputs a stepped-down DC output voltage from an output terminal, and outputs a difference between a reference voltage and the DC output voltage as an error signal, a pulse-width modulation type oscillator that subjects the output of the error amplifier to pulse width modulation, a driving circuit that generates a driving signal from a pulse signal received from the pulse-width modulation type oscillator, a pair of power semiconductor switching components that step down the DC input voltage on the basis of the driving signal from the driving circuit and generates the DC output voltage, and a soft-start circuit that detects an electric current of the power semiconductor switching components and uses the electric current for a soft-start operation and building the power-supply device in a package of a semiconductor chip including a CPU and a memory.

20. The information processing apparatus employing the IC circuit according to claim 19.
